(19) United States
(12) Patent Application Publication
(10) Pub. No.: US 2012/0254164 A1
(43) Pub. Date: Oct. 4, 2012

(54) SEARCH METHOD, SEARCH DEVICE AND RECORDING MEDIUM

(75) Inventor: Hiroyasu IDE, Hino-shi (JP)

(73) Assignee: CASIO COMPUTER CO., LTD., Tokyo (JP)

(21) Appl. No.: 13/426,912

(22) Filed: Mar. 22, 2012

(30) Foreign Application Priority Data
Mar. 30, 2011 (JP) 2011-074476

(51) Int. Cl. G06F 17/30

(52) U.S. Cl. 707/723; 707/E17.008

(57) ABSTRACT

A search device has the following configuration. An extractor extracts extracted document which includes a plurality of search strings among a plurality of document. An acquirer acquires one or more strings from each of said extracted documents, wherein each of acquired strings includes all of said search strings in each of the extracted documents. A priority determinater determines an output priority for each of said extracted document based on length of said acquired strings acquired from the extracted document. An outputter outputs said extracted document in association with said determined output priority.

### CROSS-REFERENCE TO RELATED APPLICATION

This application claims the benefit of Japanese Patent Application No. 2011-074476, filed on Mar. 30, 2011, the entire disclosure of which is incorporated by reference herein.

### FIELD

This application relates to a search method, search device and recording medium suitable for presenting the search results fulfilling the user's intention.

### BACKGROUND

As more and more electronic documents have been created, there is growing importance of search techniques for finding a desired document in a large volume of accumulated documents. A typical search method in electronic devices consists of finding documents including the search word received from the user in the search-target documents and presenting the found documents to the user.

In doing so, if many documents that include the desired search word are found, the many found documents are prioritized and displayed in the descending order of priority. Various elements are taken into account for the prioritization so that the documents suitable for the user's purpose are given higher priority in display. For example, Patent Literature 1 (Unexamined Japanese Patent Application KOKAI Publication No. 2006-106889) discloses a technique for prioritizing the documents to display in accordance with the user's level and acquiring the search results fulfilling the user's intention.

A method for prioritizing the documents in a simple manner is demanded in order to give higher priority in display to the documents fulfilling the user's intention better when there are multiple document including the desired search word. Particularly, for electronic devices smaller than conventional computers, such as electronic dictionaries, which have limited resources such as throughput and battery capacity, there is a high demand for an efficient method of prioritizing the documents and giving priority in presentation to the documents fulfilling the user's intention.

The present invention is intended to resolve the above problem and an exemplary object of the present invention is to provide a search method, search device and recording medium suitable for presenting the search results fulfilling the user's intention.

### SUMMARY

In order to achieve the above object, the search method of the present invention comprises:

an extraction step of extracting extracted documents which include a plurality of search strings among a plurality of documents;

an acquiring step of acquiring one or more strings from each of said extracted documents, wherein each of acquired strings includes all of said search strings in each of the extracted documents;

a priority determination step of determining an output priority for each of said extracted documents based on lengths of said acquired strings acquired from the extracted document; and

an output step of outputting said extracted documents in association with said determined output priority.

The present invention can provides a search method and search device suitable for presenting the search results fulfilling the user's intention.

### BRIEF DESCRIPTION OF THE DRAWINGS

A more complete understanding of this application can be obtained when the following detailed description is considered in conjunction with the following drawings, in which:

FIG. 1 is a chart showing the general configuration of the search device according to an embodiment of the present invention;

FIG. 2 is a chart showing the physical configuration of the search device according to the embodiment of the present invention;

FIG. 3 is an illustration showing the structure of a plurality of document data according to the embodiment of the present invention;

FIG. 4 is a flowchart showing the procedure executed by the search device according to the embodiment of the present invention;

FIG. 5 is an illustration showing how inclusive character strings are acquired from document data in the embodiment of the present invention;

FIG. 6 is an illustration showing how inclusive character strings are acquired from document data in the embodiment of the present invention;

FIG. 7 is a flowchart showing the candidate score setting procedure executed by the search device according to the embodiment of the present invention;

FIG. 8 is an illustration showing exemplary candidate scores set for inclusive character strings in the embodiment of the present invention;

FIG. 9 is an illustration showing exemplary candidate scores set for inclusive character strings in the embodiment of the present invention; and

FIG. 10 is a chart showing another exemplary general configuration of the search device according to the present invention.

### DETAILED DESCRIPTION

An embodiment of the present invention will be described hereafter with reference to the drawings. Here, the following embodiment is given for the purpose of explanation and does not confine the scope of the present invention. Therefore, a person of ordinary skill in the field may embrace an embodiment in which the following components are replaced with equivalent counterparts. Such an embodiment also falls under the scope of the present invention. Furthermore, the explanation of known technical matters of no importance will be omitted as appropriate in the following explanation for easier understanding.

The explanation of this embodiment will be made on the presumption that an information processing device realizing the search device is a small information processing device with the function of an electronic dictionary. In other words, the search device according to this embodiment is a device searching for and displaying document data including a desired search strings among a plurality of document data constituting an electronic dictionary.

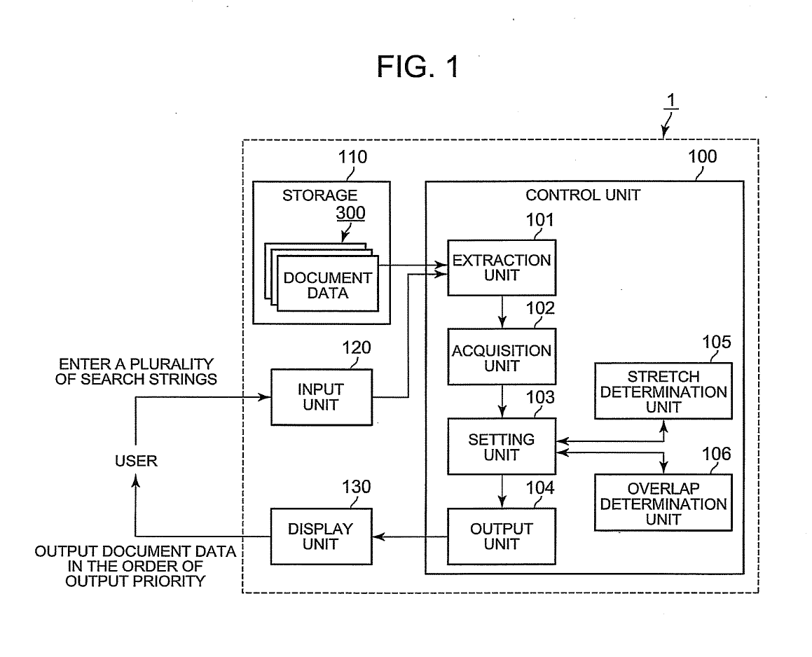

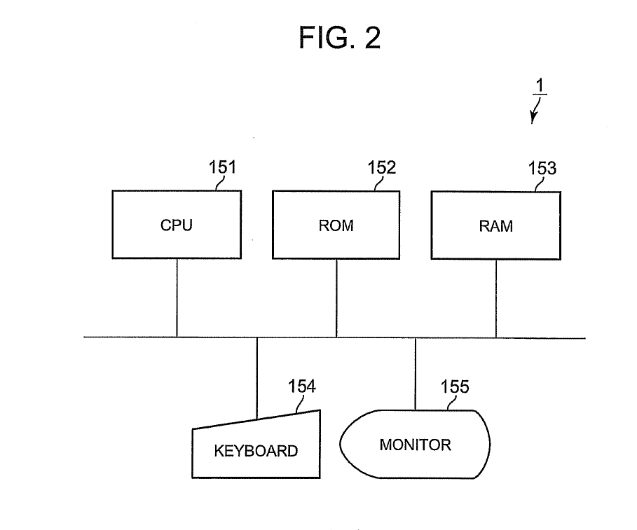

Such a search device 1 has the configuration as shown in FIG. 1, comprising a control unit 100, a storage 110, an input unit 120, and a display unit 130. On the other hand, the search device 1 has the physical configuration as shown in FIG. 2, comprising a CPU (central processing unit) 151, a ROM (read only memory) 152, a RAM (random access memory) 153, a keyboard 154, and a monitor 155. The components of the search device 1 will be described hereafter with reference to FIGS. 1 and 2,

The control unit 100 controls the entire operation of the search device 1. The control unit 100 is connected to the components and exchanges control signals and data with them. In other words, the control unit 100 is connected to the storage 110, input unit 120, and display unit 130 and, using their functions, executes the search procedure described later.

Here, the control unit 100 comprises an extraction unit 101, an acquisition unit 102, a setting unit 103, an output unit 104, a stretch determination unit 105, and an overlap determination unit 106. These units execute a procedure to identify document data including a desired search word (a plurality of search string) among a plurality of document data (a document data set 300) stored in the storage 110, sort the document data in a given order, and output them, which will be described in detail later.

The control unit 100 (the extraction unit 101, acquisition unit 102, setting unit 103, output unit 104, stretch determination unit 105, and overlap determination unit 106) physically includes, for example, a CPU 151 shown in FIG. 2. Here, the CPU 151 is mutually connected to the components via a system bus or a transfer line for transferring instructions and data and operates in accordance with computer programs and various data recorded in the ROM 152 and necessary for controlling the entire operation of the search device 1. Then, the CPU 151 controls various operations while temporarily storing in the RAM 153 computer programs and/or data read from the ROM 152 and other data necessary in the course of processing. Through the cooperation between the CPU 151 and ROM 152/RAM 153, the control unit 100 controls the units of the search device 1 and executes the following procedures.

The storage 110 is composed of a read only storage medium such as the ROM 152 incorporated in the search device 1 and stores various data necessary for the control unit 100 to conduct the search procedure. More specifically, here, the storage 110 stores a plurality of search-target document data (the document data set 300) in advance.

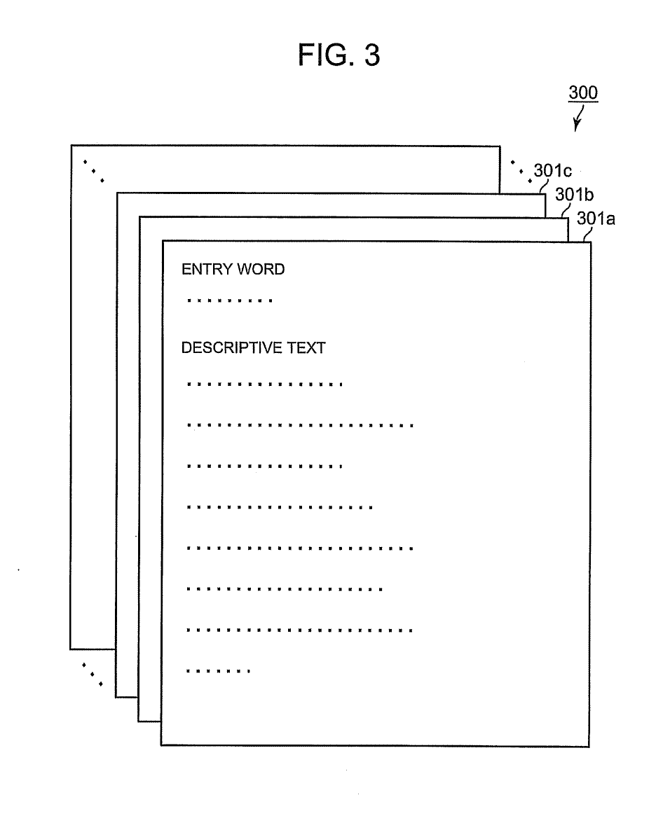

Here, the document data set 300 stored in the storage 110 in advance is constructed as shown in FIG. 3. In other words, the document data set 300 is composed of individual document data 301 (document data 301a to 301c). The document data 301 each consist of an “entry word” and “descriptive text.” In other words, the document data 301 is a constituent unit constituting a dictionary. The “entry word” is an expression serving as an entry of the dictionary. Individual document data 301 are associated with one entry word. Then, an “entry word” is associated with “descriptive text” which explains the entry word. An “entry word” and “descriptive text” together constitute individual document data 301. Furthermore, the document data 301 as many as the number of “entry words” constitute the document data set 300.

The input unit 120 includes an input device such as the keyboard 154 and receives input from the user. More specifically, here, the input unit 120 receives a search strings from the user. The received search strings is supplied to the extraction unit 101 of the control unit 100 and used in the procedure to extract the document data 301 including the search strings.

The display unit 130 is composed of a display device such as the monitor 155 and displays the results of the processing by the control unit 100 to the user. More specifically, here, the display unit 130 outputs the document data 301 including the search string entered by the user to the monitor 155 in the order of given output priority described later for display to the user. Consequently, the user can acquire the document data 301 including the search string he/she has entered as the output results and use them in a variety of ways.

Here, the input unit 120 and display unit 130 can be a device comprising a combination of an input device and display device such as a touch panel. In such a case, a position input device consisting of a touch sensor incorporated in the touch panel constitutes the input unit 120 and a display device consisting of a liquid crystal display constitutes the display unit 130.

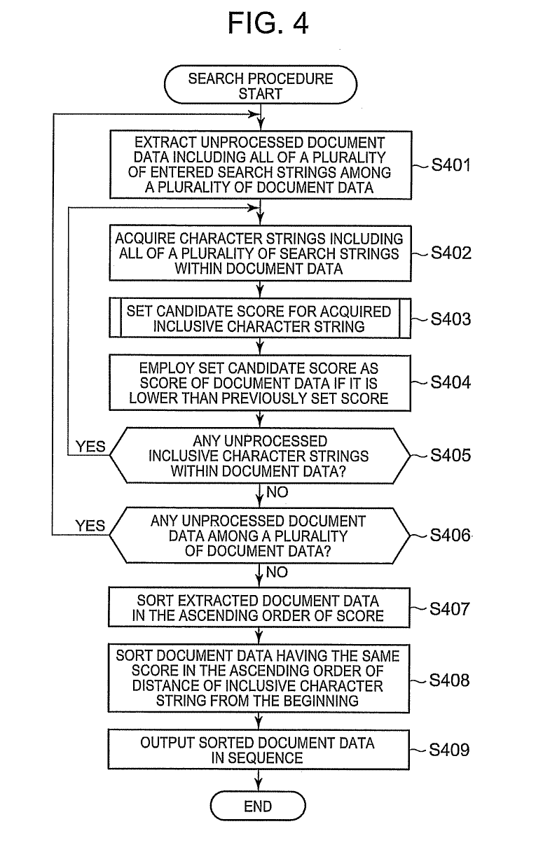

The search device 1 having the above configuration executes a search procedure under the control of the control unit 100. More specifically, the search device 1 executes the procedure shown in the flowchart of FIG. 4.

This procedure starts when the input unit 120 of the search device 1 receives a search string entered by the user. In other words, when the user enters a desired search string using the keyboard 154 and executes an operation to demand a search, the control unit 100 starts this procedure.

Here, the search device 1 can receive one or more search words (search strings) from the user. In the case of receiving a plurality of search strings, the search device 1 can search strings with various operations such as logical product and logical addition. Of such processing, this embodiment exploits its characteristic in the search procedure on the logical product of a plurality of search strings. Therefore, in the following explanation, a plurality of search strings are received from the user and the search procedure on their logical product is conducted.

When a plurality of search strings are received from the user and the search procedure starts, first, the extraction unit 101 extracts unprocessed individual document data 301 including all of the a plurality of entered search strings among a plurality of document data 301 (the document data 301a to 301c etc.) in the document data set 300 (Step S401).

For example, if the user has entered three search strings “A,” “BC,” and “DE” (here, the document data are in the Japanese or Chinese language and the letters A to E represent particular Japanese or Chinese characters), the extraction unit 101 searches the character strings in the document data set 300 and extracts the document data 301 including all of the character strings of the three search strings (search character strings) “A,” “BC,” and “DE.”

The search conducted here is full-text search through the character strings in the entry word and descriptive text of the document data 301. In other words, if the entered search strings are included in the entry word or descriptive text of individual document data 301, the document data 301 are extracted.

Here, the details of the search conducted here can be based on any known search technique. In other words, the extraction unit 101 can conduct a sequential search (a grep search) in which a plurality of document data 301 scanned in sequence to find the search character strings. Alternatively, the extraction unit 101 can conduct a look-up (index) search in which an index file is prepared in advance for conducting the search procedure at a high speed. In the case of index search, for example, the index file can be created by a so-called morphologic analysis method or by a so-called N-gram method (N-character index method).

After the document data 301 including the a plurality of search strings are extracted as described above, then, the acquisition unit 102 acquires an unprocessed character string including all of the a plurality of search strings from the extracted document data 301 (Step S402). In other words, the acquisition unit 102 acquires a character string including the plurality of entered search strings (“the inclusive character string,” hereafter) among the character strings constituting the entry word and descriptive text of the document data 301.

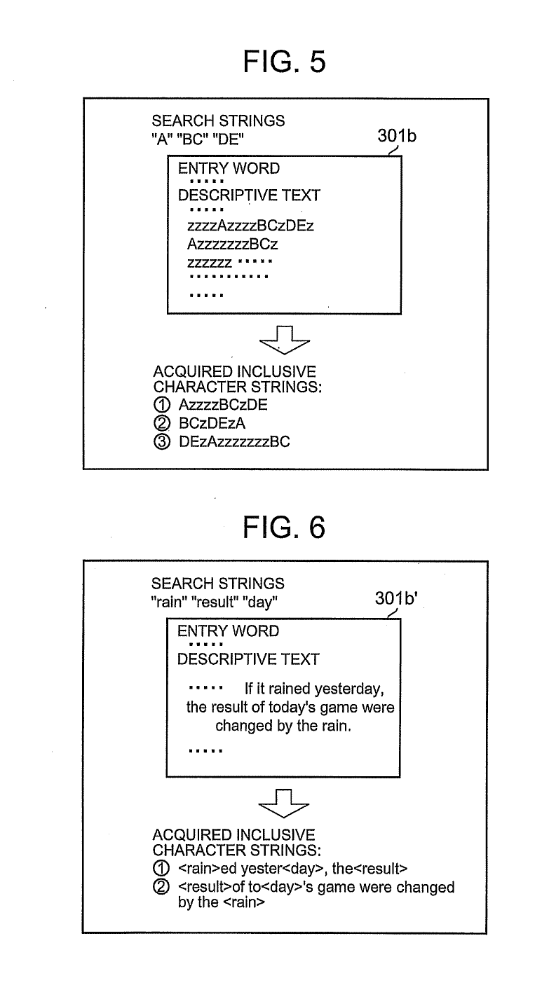

For example, in the following case, three search strings “A,” “BC,” and “DE” are entered as in the above case and Japanese or Chinese document data 301b as shown in FIG. 5 are extracted as the document data 301 including these three search character strings. In the figure, the descriptive text of the document data 301b (extracted document) includes a character string “zzzzAzzzzBCzDEzAzzzzzzzBCzzzz” (z presents any one Japanese or Chinese character). Of the three search strings, “A” appears two times, “BC” two times, and “DE” one time in the character string. In this case, a total of three inclusive character strings “AzzzzBCzDE,” “BCzDEzA,” and “DEzAzzzzzzzBC” can be acquired from this character string as the inclusive character string (acquired string) including the three search strings. If the search strings are included in other sentences of the document data 301b, the inclusive character string including the three words can further be acquired.

A case of a document in English will be described with reference to FIG. 6. In this case, three search strings (words) “rain,” “result,” and “day” are entered and document data 301b′ are extracted as the document data 301. In the figure, the descriptive text of the document data 301b′ includes a character string “If it rained yesterday, the result of today's game were changed by the rain.” Of the three search strings, the word “rain” appears two times, “result” one time; and “day” two times in the character string. Then, a total of two inclusive character strings “<rain>ed yester<day>, the <result>” and “<result> of to <day>'s game were changed by the <rain>” can be acquired from the character string as the inclusive character string including the three search strings. As described above, the inclusive character strings (acquired strings) are continuous strings in the extracted document data each of which includes all search strings.

In step S402, the acquisition unit 102 acquires one of the above acquirable inclusive character strings and temporarily stores it in the RAM 53.

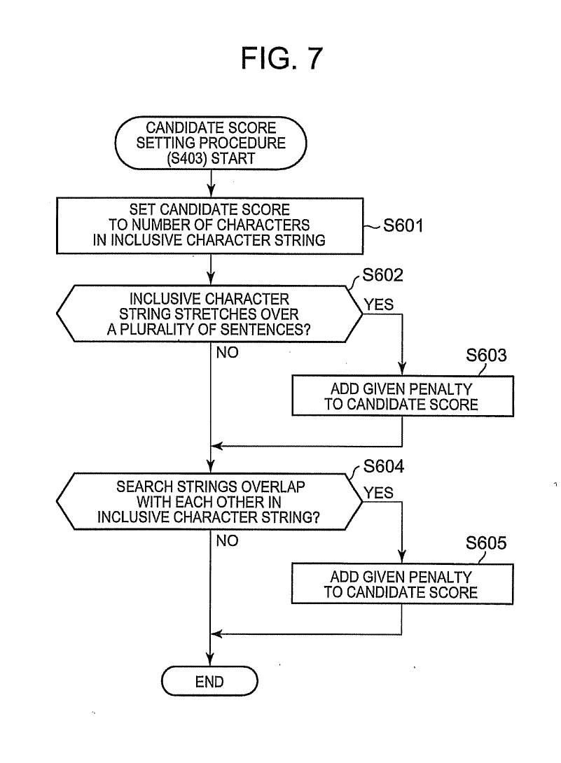

After an inclusive character string is acquired, then, the setting unit 103 sets a candidate score for the acquired inclusive character string (Step S403). Here, the candidate score is a candidate value for determining an index (score) of priority in the order of output in the procedure to output document data, which will be described later. Details of the candidate score setting procedure will be described hereafter with reference to FIG. 7.

As the candidate score setting procedure starts, first, the setting unit 103 sets the candidate score to the number of characters in the inclusive character string (Step S601). In other words, the setting unit 103 counts the number of characters in the acquired inclusive character string and sets the candidate score to it.

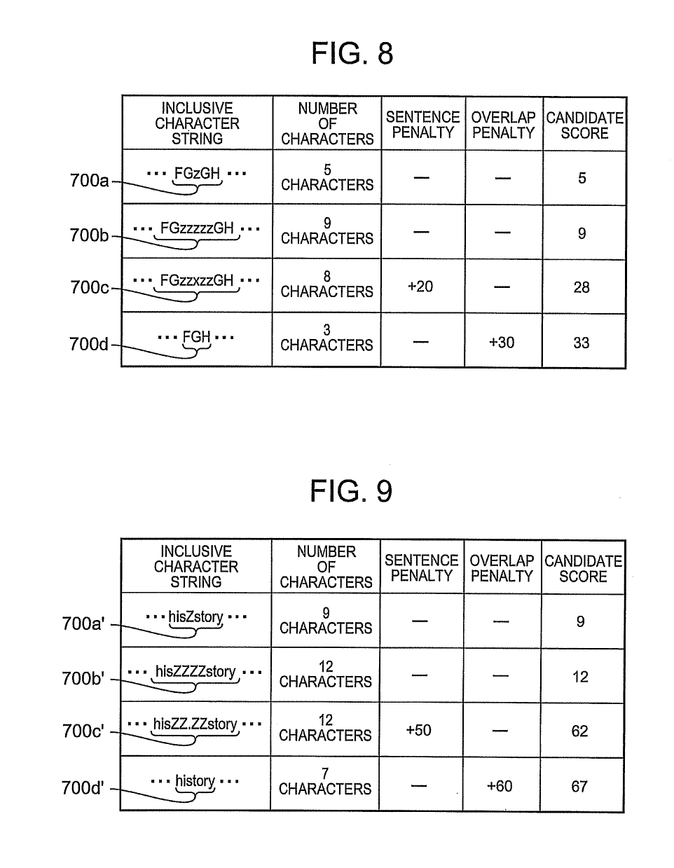

More specifically, in a case of FIG. 8, there are two search strings “FG” and “GH” (F, G, and H are particular Japanese or Chinese characters) and an inclusive character string 700a “FGzGH” (z is a Japanese or Chinese character) including the two strings is acquired from the document data 301. Here, the inclusive character string 700a has five characters; then, the candidate score of the inclusive character string 700a is set to a value “5.” On the other hand, if an inclusive character string 700b “FGzzzzzGH” is acquired from the document data 301, the inclusive character string 700b has nine characters; then, the candidate score of the inclusive character string 700b is set to a value “9.”

As seen from the above, the number of character string (length of the strings) is lower when a plurality of included search strings are closer to each other and, conversely, higher when a plurality of included search strings are away from each other. Presumably, the document data 301 in which a plurality of search strings are close to each other more often fulfills the user's intention of searching. Therefore, using the number of characters in an inclusive search string (length of the inclusive search string) as a candidate score and as an index for sorting the document data 301 described later, the document data 301 fulfilling the user's intention of searching can be given priority in output.

Then, in the candidate score setting procedure, the stretch determination unit 105 further determines whether the inclusive character string stretches over a plurality of sentences (Step S602). Here, a sentence is a so-called sentence, or a set of words generally delimited by a sentence delimiter or a period. The descriptive text of the document data 301 generally consists of one or more sentences. Here, the stretch determination unit 105 determines whether the acquired and compiled inclusive character string stretches over a plurality of sentences, in other words whether the inclusive character string includes a sentence delimiter or a period therein.

More specifically, in a case of FIG. 8 in which the acquired inclusive character string is an inclusive character string 700c “FGzzxzzGH” (x is the Japanese or Chinese sentence delimiter), the inclusive character string includes the sentence delimiter “x” and therefore is determined to stretch over a plurality of sentence.

If the inclusive character string is determined to stretch over a plurality of sentences (Step S602; YES), the setting unit 103 adds a given penalty to the candidate score (Step S603). In other words, the setting unit 103 adds a given penalty to the candidate score set to the number of characters in the inclusive character string in the Step S601 so as to increase the candidate score in value. In the case of FIG. 8, a value “20” as a sentence penalty is added to the number of characters “8” (excluding the sentence delimiter x); then, the candidate score of the inclusive character string 700c “FGzzxzzGH” stretching over a plurality of sentences is set to a value “28.”

As the candidate score is increased in value as described above, the document data 301 has the index (score) of output priority described later lowered and is moved down in the order of output to the user. In other words, compared with the document data 301 in which the plurality of search strings exist in one sentence, the document data 301 in which the plurality of search strings entered by the user are scattered over different sentences is very unlikely to be the document data 301 the user wishes to find. Therefore, such document data 301 are given lower priority in output to the user.

Here, the value of sentence penalty to be added is equal to or greater than the number of characters in the longest sentence (length of the longest sentence) among the sentences in any of the document data set 300 (a plurality of document data 301a to 301c.). The number of characters in the longest sentence in the document data set 300 is retained in the storage 110 of the search device 1 in advance and, with the addition of a given number, is used as the sentence penalty upon each search. In this way, the score of the document data 301 in which the plurality of search strings are scattered over a plurality of sentences is equal to or higher than the score of the document data 301 in which a plurality of search strings exist in one sentence. Then, the search results fulfilling the user's intention better will be output.

Then, the processing proceeds to Step S604. On the other hand, if the inclusive character string does not stretch over a plurality of sentences in the Step S602 (Step S602; NO), the processing proceeds to Step S604 without the above-described procedure to add the sentence penalty to the candidate score.

Then, in the Step S604, the overlap determination unit 106 determines whether the search strings overlap with each other in the inclusive character string (Step S604). In other words, the overlap determination unit 106 determines whether a plurality of search strings entered by the user share a character at one and the same position in an inclusive character string. If the user has entered three or more search strings, it is determined whether any two of them overlap with each other.

More specifically, in a case of FIG. 8 in which two search strings “FG” and “GH” are entered and an inclusive character string 700d “FGH” is acquired, the search strings overlap with each other in the inclusive character string. This is because the two search strings share the same character “G” in the inclusive character string 700d.

If the search strings overlap with each other in the inclusive character string as described above (Step S604; YES), the setting unit 103 adds a given penalty to the candidate score (Step S605). More specifically, in the case of FIG. 8, an overlap penalty of “30” is added to the number of characters “3”; then, the candidate score of the inclusive character string 700d “FGH” in which search strings share a character “G” is set to a value of “33.”

The candidate score is increased in value as described above because the character string in which the plurality of search strings entered by the user overlap with each other is very unlikely to comply with the usage intended by the user. Therefore, in this case, the setting unit 103 increases the candidate score in value so as to lower the priority in output to the user.

The overlap penalty to be added here is higher in value than the above-described sentence penalty. More specifically, as in the case of FIG. 8, the overlap penalty is “30”, which is higher than the sentence penalty “20”. This is because that the document data 301 in which a plurality of search strings entered by the user overlap with each other is generally less likely to fulfill the user's intention compared with the document data 301 in which the search strings stretch over a plurality of sentences.

On the other hand, if the search strings do not overlap with each other in the inclusive character string in the Step S604 (Step S604; NO), the procedure of this figure ends without the above-described procedure to add the overlap penalty to the candidate score.

The procedure to set a candidate score for documents in English will be described more specifically with reference to FIG. 9.

If there are two search strings “his” and “story” and an inclusive character string 700a′ “hisZstory” (Z is any character) including the two words is acquired from the document data 301, the number of characters is “9”; then, the candidate score is set to a value “9.” On other hand, if an inclusive character string 700b′ “hisZZZZZstory” is acquired from the document data 301, the number of characters is “12”; then, the candidate score is set to a value “12.” In other words, candidate score is determined base on the length of the acquired character string.

If the acquired inclusive character string is an inclusive character string 700c′ “hisZZ. ZZstory,” the inclusive character string includes the period “.” and therefore is determined to stretch over a plurality of sentences.

If the inclusive character string is determined to stretch over a plurality of sentences, a given penalty is added to the candidate score. In this case, a value “50” is added as the sentence penalty and the candidate score is set to a value “62.”

If two search strings “his” and “story” are entered and an inclusive character string 700d′ “history” is acquired, the search strings overlap with each other in the inclusive character string. This is because the two search strings share the same character (a character at one and the same position) “s” in the inclusive character string 700d′.

In such a case, the search strings are determined to overlap with each other in the step S604 and a value “60” is added as the overlap penalty in the Step S605. Then, the candidate score is set to a value “67.”

After the candidate score setting procedure of FIG. 7 ends, the processing of the search device 1 returns to the flowchart of FIG. 4, proceeding to Step S404. Then, if the set candidate score is lower than the previously set score, the candidate score is employed to set the score of the document data 301 (Step S404). In other words, in this embodiment, if a plurality of inclusive character strings are acquired from individual document data 301, the lowest candidate score is employed to set the score of the document data 301. To this end, the newly-set candidate score is compared in value with the previously set score and, if the candidate score is lower in value than the previously set score, the candidate score value is employed as the current score of the document data 301.

Here, in the event that the first inclusive character string is acquired from the document data 301 and no score has not been set for the document data 301, there is no need of comparison in value and the candidate score of the first inclusive character string is employed as the current score of the document data 301.

Then, the control unit 100 of the search device 1 determines whether there are any unprocessed inclusive character strings in the document data 301 (Step S405). If there are any unprocessed inclusive character strings (Step S405; YES), the processing returns to the Step S402. In other words, an unprocessed inclusive character string in the document data 301 is acquired and the candidate score of the inclusive character string is set. Then, if the set candidate score is lower than the current score already set for the document data 301, the candidate score is employed as the new, reset score of the document data 301. The above procedure is repeated for all inclusive character strings in the extracted document data 301, whereby the lowest candidate score among the candidate scores of the inclusive character strings acquired from the document data 301 is employed as the score of the document data 301.

If there are no more unprocessed inclusive character strings (Step S405; NO), then, the control unit 100 of the search device 1 determines whether there are any unprocessed document data 301 including the plurality of entered search strings among all document data 301 (the document data 301a to 301c) of the document data set 300 (Step S406). If there are any unprocessed document data 301 (Step S406; YES), the processing returns to the Step S401. The above processing is repeated and the score is set for all document data 301 including the plurality of entered search strings.

If there are no more unprocessed document data 301 (Step S406; NO), then, the output unit 104 sorts the extracted document data 301 in the ascending order of score (Step S407). In other words, the output unit 104 compares the set scores of the document data 301 and sorts them in the ascending order.

Then, the output unit 104 further sorts the document data 301 having the same score (Step S408). More specifically, focusing on the position of the inclusive character string in the document data 301 with which the score is set (the lowest candidate score is obtained), the output unit 104 sorts the document data 301 in the manner that the document data 301 is ranked higher as the above position is closer to the beginning.

The reason for the above sorting is that more important description appears near the beginning (the entry word) in search-target documents in this embodiment (such as dictionary data). In other words, the document data 301 in which a plurality of search strings entered by the user are situated closer to the beginning are more likely to be the document data 301 fulfilling the user's intention compared with the document data 301 in which the search strings are away from the beginning.

Then, the output unit 104 outputs the sorted document data 301 in sequence (Step S409) and the procedure ends. In other words, the output unit 104 sends the sorted document data 301 to the display unit 130 and displays them on the monitor 155 of the search device 1 to output them to the user in the sorted order. Consequently, the user can view the document data 301 fulfilling his/her own intention in sequence for use.

Having the above configuration, the search device 1 of this embodiment ranks the document data 301 including a plurality of search strings among a plurality of document data 301 based on the number of characters in a character string including the plurality of search strings (length of the strings) and the like and outputs the document data 301 including the plurality of search words to the user in the set order.

Consequently, determining the priority by a simple method, the search device 1 of this embodiment can present the search results fulfilling the user's intention. Particularly, the search method of this embodiment is effective for such an information device which may generate consistently common occurrence of found pair of search strings, or for a small information device having limited performances of their CPU, memory and/or battery.

Here, the above embodiment is given by way of example and the scope of application of the present invention is not confined thereto. In other words, various applications are available and any embodiment falls under the scope of the present invention.

For example, in the above embodiment, the search device 1 stores the document data set 300 in the storage 110 such as the ROM 152. However, this is not restrictive. The search device 1 can comprise a large capacity storage device such as a hard disc or a DVD-ROM drive and store the document data set 300 in the hard disc or DVD-ROM. Alternatively, it is possible to connect the search device 1 to a network and allow the document data set 300 to exist on the network.

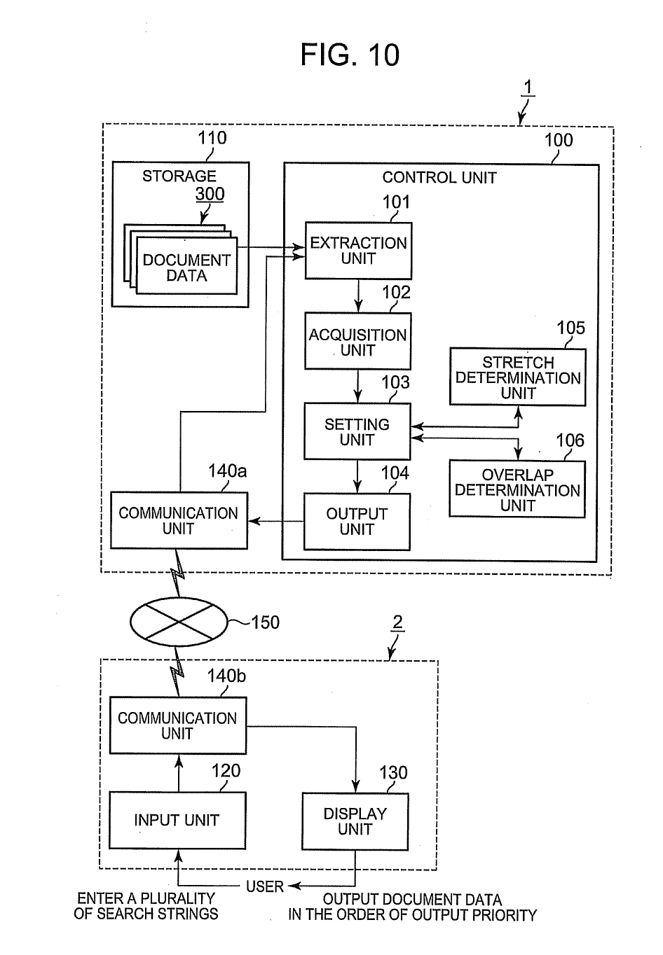

Furthermore, in the above embodiment, the search device 1 has the input unit 120 for the user to enter search strings and the display unit 130 displaying the search results in the same device as the control unit 100 and storage 110. However, this is not restrictive. The input unit 120 and display unit 130 can be outside the search device 1. In other words, for example as shown in FIG. 10, the search device 1 does not incorporate the input unit 120 and display unit 130, but is connected to a terminal device 2 incorporating them via a network 150 so that the search device 1 is configured as an online information device such as an electronic dictionary.

In such a case, the search device 1 and terminal device 2 exchange data via the network 150 through their communication units 140a and 140b. In other words, a plurality of search strings entered by the user via the input unit 120 of the terminal device 2 are sent to the search device 1, where the search procedure is conducted by the control unit 100. Then, document data information as the search results, with which the output priority set for each of them is associated, is sent back to the terminal device 2 and displayed to the user of the terminal device 2 via the display unit 130 in the descending order of output priority. With such a configuration, the document data set 300 in the search device 1 can be administered collectively and used by multiple users. Furthermore, the user terminal device 2 does not need to retain the document data set 300 and, advantageously, its data size can be reduced.

Furthermore, in the above embodiment, the search device 1 is a small information processing device such as an electronic dictionary. However, this is not restrictive. The search device 1 can be a conventional business or home computer device, cell-phone, or any other information device. Furthermore, the search can be conducted not only on electric dictionaries but also for various electronic data. For example, the search can be conducted on a conventional computer device for an electronic file including a desired search character string among electronic files stored in a large capacity storage device such as a hard disc or in a DVD-ROM. Alternatively, it is possible to connect the search device 1 to a network in search for web pages on the network.

Furthermore, in the above embodiment, a plurality of document data 301 constituting the document data set 300 each consist of an “entry word” and “descriptive text.” However, this is not restrictive. They can consist of various elements. For example, they can have illustrations and tables for explaining the “entry word.” Alternatively, for conventional electronic file search other than dictionary search, the components are not restricted to the “entry word” and “descriptive text” and the document data 301 can have character string data in various forms.

Furthermore, in the above embodiment, the document data 301 includes one or more sentences and the stretch determination unit 105 determines whether an inclusive character string stretches over a plurality of sentences. In doing so, the sentence delimiter or period is considered to be a delimiter between sentences. However, this is not restrictive and a phrase delimiter or a comma, colon, or semicolon can be used as a delimiter between sentences. In other words, the stretch determination unit 105 determines whether an inclusive character string stretches over a phrase delimiter or comma and, if so, adds a given sentence penalty to the candidate score of the inclusive character string.

Here, additionally, the value of sentence penalty to be added can vary depending on the type of delimiter. In other words, for example, the value of sentence penalty to be added when a sentence delimiter is included can be higher than the value of sentence penalty to be added when a phase delimiter is included. With such adjustment in the value of sentence penalty to be added depending on the type of delimiter, the search results will be output in the order fulfilling the user's intention better.

Similarly, the value of overlap penalty to be added to the candidate score of an inclusive character string when the overlap determination unit 106 determines that a plurality of search strings overlap with each other in the inclusive character string is not limited to a single predetermined value. In other words, for example, the value of overlap penalty to be added when two search strings share two characters may be higher than the value of overlap penalty to be added when two search strings share one character. Alternatively, the value of overlap penalty to be added when one search strings completely includes another search strings may be higher than the value of overlap penalty to be added when two search strings partially overlap with each other.

More specifically, for example, if the user enters two search strings “about” and “out,” any inclusive character string including the character string “about” includes the character string “out.” However, such an inclusive character string is not considered to include the word “out.” Therefore, such an inclusive character string is more unlikely to fulfill the user's intention compared with the one in which two search strings partially overlap with each other. Then, the value of overlap penalty to be added when one search strings completely includes another search strings can be higher than the value of overlap penalty to be added when two search strings partially overlap with each other. With such adjustment in the value of overlap penalty to be added depending on the degree of overlap, the search results will be output in the order fulfilling the user's intention better.

Needless to say, a search device in which the configuration for realizing the function according to the present invention is incorporated in advance can be provided. In addition, an existing personal computer or information terminal device can be made to function as the search device according to the present invention by applying programs. In other words, application of search programs for realizing the functional configuration of the search device 1 exemplified in the above embodiment to allow a CPU controlling an existing personal computer or information terminal device to execute them leads to the existing personal computer or information terminal device functioning as the search device 1 according to the present invention. Furthermore, the search method according to the present invention can be implemented using the search device 1.

Such programs can be applied by any method. For example, the programs can be stored and applied on a computer-readable recording medium such as a CD-ROM, DVD-ROM, and memory card, or applied via a communication medium such as the Internet.

A preferred embodiment of the present invention is described above. The present invention is not confined to this particular embodiment. The present invention includes the invention set forth in the scope of claims and its equivalent scope.

Having described and illustrated the principles of this application by reference to one (or more) preferred embodiment(s), it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. A search method, comprising:
an extraction step of extracting extracted documents which include a plurality of search strings among a plurality of documents;
an acquiring step of acquiring one or more strings from each of said extracted documents, wherein each of acquired strings includes all of said search strings in each of the extracted documents;
a priority determination step of determining an output priority for each of said extracted documents based on lengths of said acquired strings acquired from the extracted document; and
an output step of outputting said extracted documents in association with said determined output priority.

2. The search method according to claim 1, wherein:
in said priority determination step, said output priority is determined for each of said extracted documents based on a lowest length among said lengths of acquired strings.

3. The search method according to claim 2, further comprising:
a stretch determination step of determining for each of said acquired strings whether said acquired strings stretches over a plurality of sentences of said extracted document; wherein
each of said plurality of documents includes a plurality of said sentences,
in said priority determination step, if said acquired string is determined to stretch over a plurality of sentences, a sum of a given value and said length of said acquired string is used as said length for determining said output priority.

4. The search method according to claim 3, wherein:
in said priority determination step, said given value is set to be equal to or greater than said value of sentence length of the longest sentence among said sentences included in any of said plurality of documents.

5. The search method according to claim 2, further comprising:
an overlap determination step of determining whether said search strings included in said acquired string share a character at a same position of said acquired string; wherein
in said priority determination step, a sum of a given value and said length of said acquired string is used as said length for determining said output priority if it is determined that said plurality of search strings share a character.

6. The search method according to claim 5, wherein:
in said priority determination step, said given value is set to be equal to or greater than said value of the sentence length of longest sentence among said sentences included in any of said plurality of document.

7. The search method according to claim 2, wherein:
in said output step, said extracted documents are output so that said extracted documents for which said output priority are determined to be the same are output associated with the secondary output priority which is determined based on a distance between a head character of the extracted document and said acquired string with which the same output priority of the document is determined.

8. A search device, comprising:
an extractor extracting extracted document which includes a plurality of search strings among a plurality of document;
an acquirer acquiring one or more strings from each of said extracted documents, wherein each of acquired strings includes all of said search strings in each of the extracted documents;
a priority determinater determining an output priority for each of said extracted document based on length of said acquired strings acquired from the extracted document; and
an outputter outputting said extracted document in association with said determined output priority.

9. The search device according to claim 8, wherein:
said priority determinater determines the output priority for each of said extracted document based on a lowest length among said lengths of acquired strings.

10. The search device according to claim 9, further comprising:
a stretch determiner determining for each of said acquired strings whether said acquired strings stretches over a plurality of sentences of said extracted document, wherein
each of said plurality of documents includes a plurality of said sentences,
said priority determinater uses, if said acquired string is determined to stretch over a plurality of sentence, a sum of a given value and said length of said acquired string as said length for determining said output priority.

11. The search device according to claim 10, wherein:
said priority determination uses, as said given value, a value of sentence length of the longest sentence among said sentences included in any of said plurality of documents.

12. The search device according to claim 9, further comprising:
an overlap determiner determining whether said search strings included in said acquired string share a character at a same position of said acquired string; wherein
said priority determinater uses a sum of a given value and the length of said acquired string as said length for determining said output priority if it is determined that said plurality of search strings share a character.

13. The search device according to claim 12, wherein:
said priority determination uses, as said given value, a value set to be equal to or higher than value of the sentence length of longest sentence among said sentences included in any of said plurality of document.

14. The search device according to claim 9, wherein:
said outputter outputs said extracted document so that said extracted documents for which said output priority are determined to be the same are output associated with the secondary output priority which is determined based on a distance between a head character of the extracted document and said acquired string with which the same output priority of the document is determined.

15. A medium on which programs for allowing a computer to execute the following steps are recorded in a computer-readable fashion:
an extraction step of extracting extracted documents which include a plurality of search strings among a plurality of documents;
an acquiring step of acquiring one or more strings from each of said extracted documents, wherein each of acquired strings includes all of said search strings in each of the extracted documents;
a priority determination step of determining an output priority for each of said extracted documents based on lengths of said acquired strings acquired from the extracted document; and
an output step of outputting said extracted documents in association with said determined output priority.

16. The recording medium according to claim 15, wherein:
in said priority determination step, said output priority is determined for each of said extracted documents based on a lowest length among said lengths of acquired strings.

17. The recording medium according to claim 16 allowing a computer to further execute:
a stretch determination step of determining for each of said acquired strings whether said acquired strings stretches over a plurality of sentences of said extracted document; wherein
each of said plurality of documents includes a plurality of said sentences,
in said priority determination step, if said acquired string is determined to stretch over a plurality of sentences, a sum of a given value and said length of said acquired string is used as said length for determining said output priority.

18. The recording medium according to claim 17, wherein:
in said priority determination step, said given value is set to be equal to or greater than said value of sentence length of the longest sentence among said sentences included in any of said plurality of documents.

19. The recording medium according to claim 16, allowing a computer to further execute:
an overlap determination step of determining whether said search strings included in said acquired string share a character at a same position of said acquired string; wherein
in said priority determination step, a sum of a given value and said length of said acquired string is used as said length for determining said output priority if it is determined that said plurality of search strings share a character.

20. The recording medium according to claim 16, wherein:
in said output step, said extracted documents are output so that said extracted documents for which said output priority are determined to be the same are output associated with the secondary output priority which is determined based on a distance between a head character of the extracted document and said acquired string with which the same output priority of the document is determined.
